(19) United States
(12) Patent Application Publication
(10) Pub. No.: US 2010/0015274 A1
(43) Pub. Date: Jan. 21, 2010

(54) INJECTION MOULDING NOZZLE AND TIP THEREFOR

(75) Inventor: Robert John Fill, Auckland (NZ)

Correspondence Address: YOUNG & THOMPSON, 209 Madison Street, Suite 500, Alexandria, VA, 22314, US

(73) Assignee: VOLASTIC LIMITED, Auckland (NZ)

(21) Appl. No.: 12/298,442

(22) PCT Filed: Apr. 24, 2007
(86) PCT No.: PCT/NZ2007/000094

§ 371 Date: Jan. 27, 2009

(30) Foreign Application Priority Data
Apr. 24, 2006 (NZ) 546761

(51) Int. Cl. B29C 45/72; B29C 45/20

(52) U.S. Cl. 425/549; 425/567; 425/569

(57) ABSTRACT

An injection moulding tip (3) for an injection moulding nozzle assembly (100) has an inlet (4a) at a first end, at least one outlet (4b) at a second end and a flow path (4) between the inlet (4a) and the outlet (4b). A first portion (26) of the tip (3) adjacent the first end has a first diameter, a second portion (31) adjacent the second end has a second diameter, and a central portion (29) between the first and second portions has a diameter that is greater than the first and second diameters. An injection moulding tip is also disclosed.

### FIELD OF THE INVENTION

The present invention relates to nozzles for injection moulding of plastic, and in particular, but not exclusively, to a “hot runner” type of nozzle.

### BACKGROUND OF THE INVENTION

In “hot runner” style injection moulding, the plastic flows into a mould through a heated nozzle. The plastic flows through a tip, which is typically made from a relatively highly thermally conductive material such as beryllium copper. The tip is typically positioned relative to the gate opening of the mould by a locating means such as a locating nut. The nut is often made from a material which has relatively poor thermal conductivity such as titanium, in order to insulate the tip from the mould.

Present designs of nozzles have a number of disadvantages.

Many nozzles of the prior art raise the temperature of the plastic within the nozzle to a peak many tens of degrees higher than the optimum injection temperature in order to ensure that it exits the nozzle at around the correct temperature. This may be particularly undesirable when modern composite plastics are used, as some of these materials may have a relatively narrow range of temperatures (i.e. “operating window”) within which the plastic stays molten, but does not degrade.

The temperature of the nozzles of the prior art is monitored and controlled in order to ensure that the temperature of the plastic exiting the nozzle is within a required range.

The temperature variation within the nozzles of the prior art has traditionally been so great that the position of the sensor taking this measurement has been critical in order to achieve a representative measurement.

### OBJECT OF THE INVENTION

It is an object of the present invention to provide an injection moulding nozzle which will overcome or ameliorate at least one problem of nozzles of the prior art, or at least one which will provide a useful choice.

Further objects of the invention will become apparent from the following description.

### SUMMARY OF THE INVENTION

According to the first broad aspect of the present invention there is provided an injection moulding tip for an injection moulding nozzle assembly, the tip including;
An inlet at a first end,
An outlet at a second end,
A flow path between the inlet and the outlet,
A first portion adjacent to the first end having a first diameter,
A second portion adjacent to the second end having a second diameter,
And a central portion between the first and second portions, the central portion having a diameter that is greater than the first diameter and greater than the second diameter.

Preferably an external surface of the central portion is continuous with an external surface of a nozzle body to which the tip is to be connected.

Preferably the first portion of the tip is adapted to connect to a nozzle body.

Preferably the second portion of the tip is adapted to be connected to a locating means for locating the nozzle assembly relative to a mould.

Preferably the flow path is provided by a tip liner which may comprise an integral part of the tip, or which may comprise a separable component from the tip.

Preferably the first and second portions each include an external thread.

Preferably the tip is constructed from a highly thermally conductive material such as beryllium copper, or a highly thermally conductive carbide material.

Preferably the locating means comprises a material having a significantly lower thermal conductivity than the material of the tip.

Preferably the nozzle body comprises a material having a significantly lower thermal conductivity than the tip.

According to a second broad aspect of the invention there is provided an injection moulding tip for an injecting moulding nozzle, the tip being constructed from a highly thermally conductive material, and including;
A first portion for connection to the nozzle body,
A second portion for connection to a locating means,
A central portion disposed between the first and second portions, the central portion having an external surface adapted to contact a heating means.

Preferably the tip comprises at least 20% of the total mass of a nozzle assembly with which it is connected in use.

Preferably the tip may include a sleeve and a tip liner provided inside the sleeve, the tip liner defining a flow path, wherein the sleeve comprises at least 14% of the total mass of a nozzle assembly with which it is connected in use.

Preferably the sleeve is substantially double the mass of the tip liner.

Preferably the central portion of the tip comprises at least substantially 50% of the total mass of the tip excluding the tip liner.

According to a further broad aspect of the present invention there is provided an injection moulding nozzle including;
A nozzle body;
a tip adapted for provision on the body, the tip having an inlet, an outlet, a fluid flow path between the inlet and the outlet, a shank portion between the inlet and the outlet, and an external surface of the shank portion being adapted to contact a heating means.

Preferably the shank portion includes a sleeve, an outer surface of which provides the external surface of the shank portion which is adapted to contact the heating means, and a tip liner provided within the sleeve in which the flow path is provided.

Preferably, the sleeve is in intimate thermal contact with the tip liner between the inlet and said at least one outlet.

Preferably the tip has a high thermal conductivity.

Preferably the sleeve has a high thermal conductivity.

Preferably, the tip liner has a high thermal conductivity.

Preferably the nozzle includes a heating means in contact with the outer surface of the sleeve.

Preferably, the nozzle includes a cover or housing and the heating means is attached to or integral with said cover or housing.

Preferably, the sleeve has a thermal conductivity of at least three times that of the housing and/or nozzle body, and more preferably at least five times that of the housing and/or nozzle body.

Preferably, the nozzle may include a body having an inlet, an outlet and a fluid path extending between the inlet and the outlet, wherein in use the body is positioned such that the outlet is in fluid communication with the inlet of the tip.

Preferably, the tip may be constructed from beryllium copper.

Preferably, the sleeve may be constructed from beryllium copper.

Preferably, the tip liner may be constructed from a carbide having a thermal conductivity approximately equal to that of the sleeve.

Preferably the sleeve extends substantially the distance between the inlet and outlet of the elongate tip.

Preferably the tip has a first end adapted for disposal internally of the body and a second end adapted for disposal internally of the locating means.

Preferably the sleeve has a first end adapted for disposal internally of the body and a second end adapted for disposal internally of the locating means.

According to a further aspect of the present invention there is provided a body for an injection moulding nozzle assembly, the body including a first end provided with an inlet, a second end provided with an outlet and a flow path between the inlet and outlet, the body further including a flange portion at or adjacent the first end, a shank portion extending between the flange portion and the second end, and a substantially annular member provided on the shank portion and adapted to engage a heater means of the injection moulding nozzle when in use.

Preferably, the substantially annular member is provided with an internal annular rebate adapted to fit over the heater means.

Preferably, the substantially annular member is manufactured from a different material to the rest of the nozzle body.

According to a further aspect of the present invention an injection moulding nozzle is provided substantially as herein described with reference to the accompanying figures.

Further aspects of this invention, which should be considered at all as novel aspects, will become apparent from the following description given by way of example of possible embodiments thereof and in which reference is made to the accompanying drawings.

### BRIEF DESCRIPTION OF THE FIGURES

FIG. 1 is a side view of a nozzle according to one embodiment of the present invention.

FIG. 2 Is a cross section of the nozzle shown in FIG. 1 through plane A-A.

FIG. 3 Is a diagrammatic illustration of a part of FIG. 2, showing heat flow.

FIG. 4 Is a diagrammatic cross section of an alternative embodiment of a tip according to the present invention.

FIG. 5 Is an enlarged diagrammatic cross section of a sleeve of the tip of FIG. 4.

FIG. 6 Is a cross-section of an upper portion of a nozzle body according to one embodiment of the present invention.

### BEST MODE FOR PERFORMING THE INVENTION

Where reference is made to materials herein, those references are to be understood as including alloys of the materials having similar properties.

The term “thermal conductivity” is used in the sense of heat transferred per square meter of surface area per degree temperature difference, e.g. W/mK.

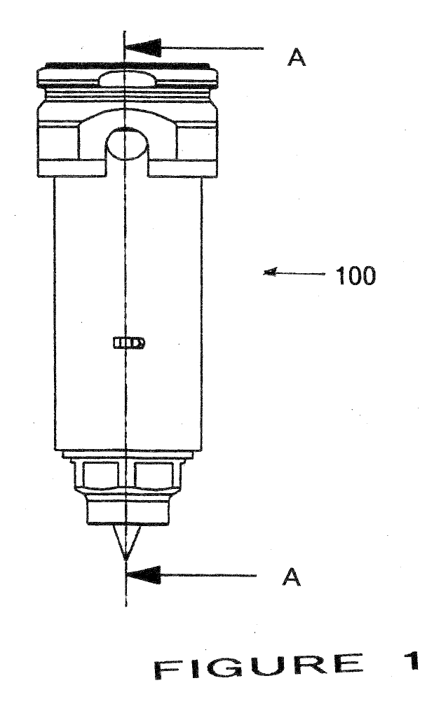

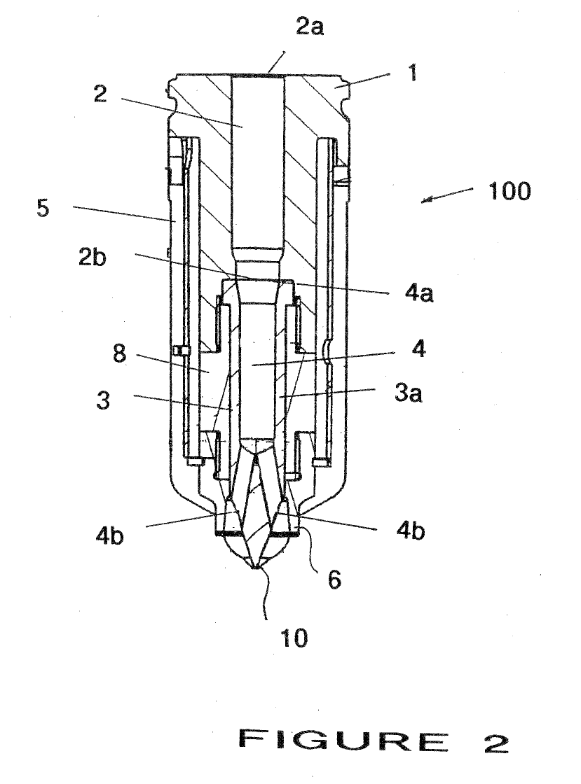

Referring first to FIGS. 1 and 2, an injection moulding nozzle is generally referenced 100.

The nozzle 100 includes a body 1 with a channel 2 therethrough providing a fluid path between an inlet 2a and an outlet 2b. An elongate tip, generally referenced 3, is positioned adjacent the body 1. The tip 3 includes a tip liner 3a with a channel 4 therethough providing a fluid path between an inlet 4a and at least one outlet 4b.

The nozzle 100 has a housing or cover 5 which is preferably attached to or integral with a heating means such an electrical element (not shown). The tip 3 is aligned relative to a mould gate, by a locating means such as a locating nut 6 which engages with a sleeve 8.

When in the correct position the inlet 4a of the tip 3 substantially aligns with the outlet 2b of the body, so that, in use, molten plastic is able to flow from a manifold or machine nozzle (not shown), through the channels 2 and 4, and then into a mould (not shown) via the one or more outlet apertures 4b provided in the tip 3 and gate 10. In the embodiment shown two outlet apertures 4b are used.

The sleeve 8 is provided between the tip liner 3a and the heating means. In another embodiment of the invention the sleeve 8 and tip liner are integrally formed (i.e. the tip is cast or otherwise formed with the sleeve 8 and liner 3a as integral parts thereof), or the tip liner 3a is connected to the sleeve 8 such that the sleeve 8 and the tip liner 3a comprise a single article (for example by using an interference fit). The sleeve 8 is in intimate thermal contact with the tip liner 3a and the heating means, and is preferably in contact with the tip liner 3a for substantially the majority, or all of the length of the shank of the tip liner 3a i.e. that elongate part of the tip liner 3a substantially between the inlet 4a and the outlet aperture(s) 4b. In a preferred embodiment the sleeve 8 has external threads to engage one end of the sleeve with the body 1 and the other end with the locating means 6 so that it extends internally into the body at one end and the locating means at the other end. The sleeve 8, if provided as a separate component from the tip liner 3a, may also retain the tip 3 relative to the body 1.

The sleeve 8 and the tip liner 3a are made from a material which has a high thermal conductivity, typically being higher than the body and the locating means 6. In a preferred embodiment the tip liner 3a may be made from a carbide having a high thermal conductivity (i.e. a thermal conductivity similar to that of beryllium cooper, or be made from beryllium copper, or such other suitable material as is known to those skilled in the art to have similar thermal properties). Thus in at least one embodiment the tip is constructed from materials that are at least approximately three to five times more thermally conductive than the body of the nozzle and/or the housing. In one embodiment the sleeve 8 has a cylindrical aperture in which the tip liner 3a is disposed, and has at least a central cylindrical external surface of greater diameter than the ends, the central cylindrical surface being provided for intimate thermal contact with the heating means. Therefore, the tip 3 has first and second portions of reduced diameter adjacent to the inlet and outlet respectively, and a central portion of increased diameter which contacts the heating means.

The sleeve 8 is preferably manufactured from beryllium copper or such other suitable material as may be known to those skilled in the art to have a similar or better thermal conductivity, and a similar or higher yield temperature. In one embodiment both the sleeve and the liner may be made from carbide.

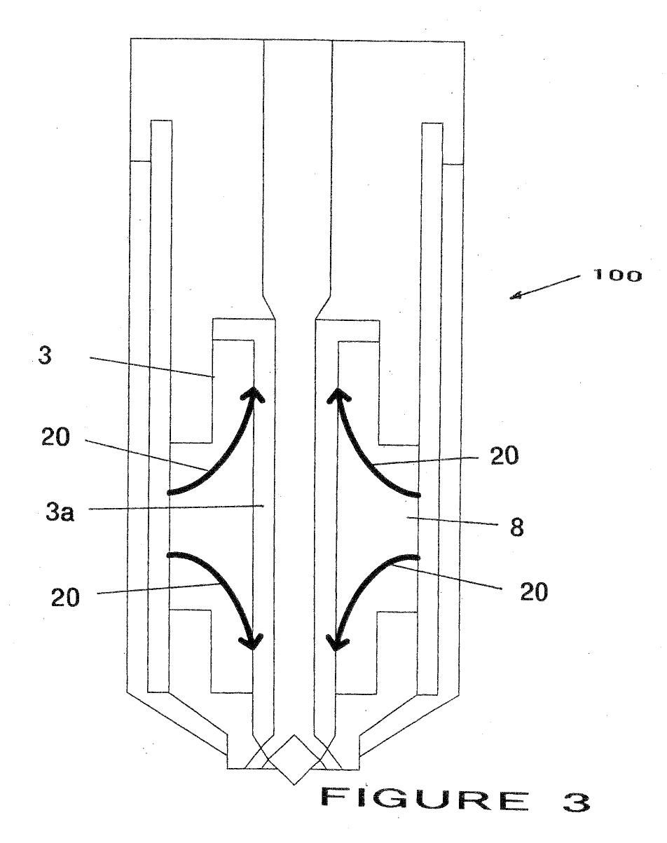

The heat is applied to the tip 3 through the larger diameter central portion of the sleeve 8, rather than heat being applied at either end of the tip 3. This means that heat loss through to the mould is reduced relative to nozzles in which the heating means extends further towards the outlet of the nozzle. However, as can be seen with reference to FIG. 3, the high thermal conductivity of the sleeve 8 allows a high proportion of the heat absorbed by the sleeve 8 from the heating means to flow into the plastic in the flow path 4 as shown by arrows 20, rather than flowing through the less thermally conductive nozzle body and/or locating unit. Because the liner 3a is also manufactured from a highly conductive material, heat is applied to the plastic within the flow path 4 along the entire length of the flow path 4.

The tip 3 has a sufficient mass that it can act as a thermal reservoir, that is, it has a large thermal capacity compared to the plastic in the flow path 4. If the temperature of the plastic flowing through the tip 3 is momentarily cooler than the required temperature then the sleeve 8 preferably retains sufficient energy that is able to heat the plastic without a significant drop in the temperature of the tip 3.

By providing the thermally conductive sleeve 8 and liner 3a the temperature of the plastic within the tip 3 may be kept much more constant than is possible with the nozzles of the prior art. The applicant has found that in some embodiments the heat flow from the heater to the tip may be so good, and the temperatures so even, that the position of the sensor measuring the temperature of the plastic flowing through the nozzle is much less critical than in the nozzles of the prior art. In some embodiments a sensor positioned on or adjacent to the heating means may provide a temperature measurement which is sufficiently indicative of the temperature of the plastic within the tip that a sensor near or within the tip is not required.

The locating means may, if required, have a lower thermal conductivity than the tip and may, for example, be made from steel or titanium. However, because the sleeve 8 transfers heat so well to the tip liner 3a and flow path 4, it is not generally necessary to insulate the tip 3 from the mould with a locating means having a relatively low thermal conductivity. In some embodiments a more conductive locating means may be used to assist in dissipating the heat generated by shear as the plastic leaves the outlet aperture(s). Those skilled in the art will recognize the circumstances in which the heat generated by shear is likely to require the use of a locating means which has relatively good thermal conductivity.

Preferred embodiments of the invention may be constructed in accordance with one or more of the following parameters:
1. tip including sleeve comprises at least 20% (or preferably between 20% and 37%) of the total mass of injector
2. sleeve portion without tip liner comprises at least 14% (or preferably between 14% and 25%) of the total mass of injector.
3. the sleeve is substantially double the mass of the tip liner.
4. the expanded central portion of the sleeve is at least approximately 50% of the total mass of the sleeve.

As another example, injection assemblies according to the invention may include components having the following percentage by weight of the overall nozzle assembly:

| | |
|---|---|
| (a) Body | 45-72% |
| (b) Sleeve | 14-25% |
| (c) Tip Liner | 6-12% |
| (d) Nut | 7-16% |

Those skilled in the art will appreciate that the present invention provides an injection moulding nozzle which may provide improved heat transfer between the heater and the plastic, and may thereby provide a reduced temperature variation of the plastic within the nozzle. The sleeve conducts heat from an external surface internally to the top and projects internally of the body and the locating means so that heat is transferred efficiently to the tip and is not dispatched unnecessarily externally of the locating means.

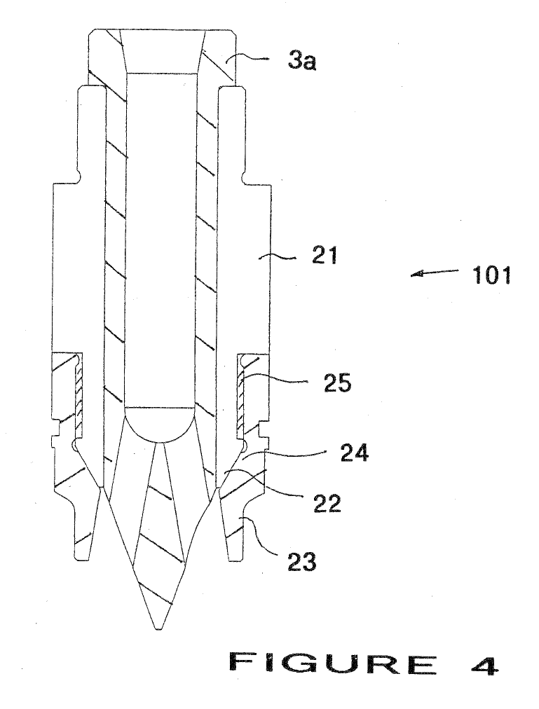

Referring next to FIG. 4, an alternative embodiment of the tip is generally referenced 101. In this embodiment the sleeve 21 has a tapered end 22, over which a locating means such as a nut 23 with a correspondingly tapered internal surface 24 is fastened in use. The locating means 23 is preferably fastened to the sleeve 21 by a suitable threaded portion 25.

The locating means is preferably made from a material having a relatively low coefficient of thermal expansion, for example steel. This means that the sleeve 21 is constrained from expanding in the radial direction, but some expansion in the axial direction is possible. Expansion of the sleeve 21 in the axial direction tends to cause the tapered end 22 of the sleeve to be pressed into closer contact with the tip liner 3a by the tapered internal surface 24 of the locating means. In this way the penetration of molten plastic into the interface between the tip liner 3a and the sleeve 21, and between the sleeve 21 and the locating means 23, is minimised, regardless of the potentially significant differences in coefficient of thermal expansion between the components.

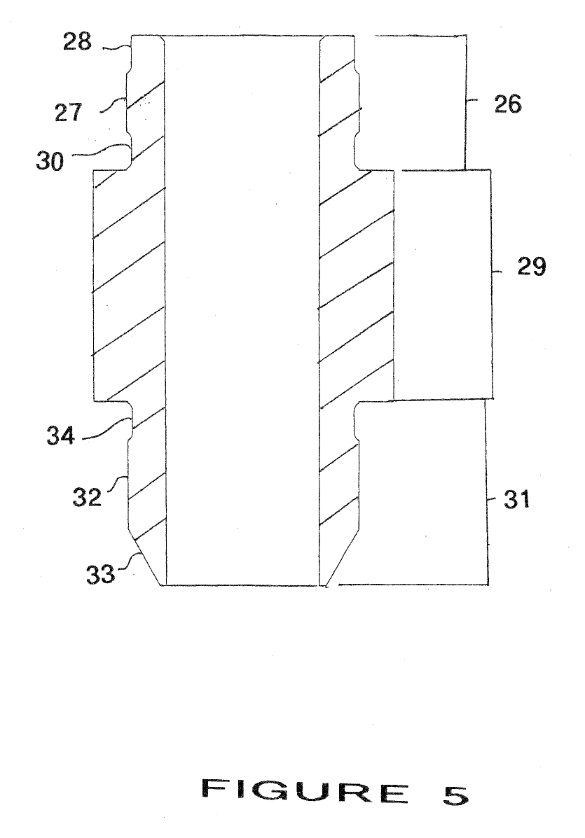

Referring next to FIG. 5, the first end portion 26 of the sleeve 21 preferably has a central zone 27 of substantially the same diameter as interior of the body of the nozzle (not shown). At the end of the first portion 26 nearest the end of the sleeve 21 is a first compressible zone 28 having a reduced diameter relative to the central zone 27. At the opposite end of the first end portion 26, between the central zone 27 and the enlarged diameter central portion 29 of the sleeve 21, is an extensible zone 30, also having a reduced diameter relative to the central zone 27. The compressible and extensible zones allow the body of the nozzle to be fastened hard against the shoulder of the central portion 29, thereby improving the stiffness of the assembly.

Similarly, the second end portion 31 of the sleeve 21 has a second central zone 32 and a second compressible zone 33 between the second central zone 32 and the end of the sleeve 21. A second extensible zone 34 is provided between the central portion 29 and the second central zone 32. This allows the locating means to be fastened hard against the shoulder of the central portion 29.

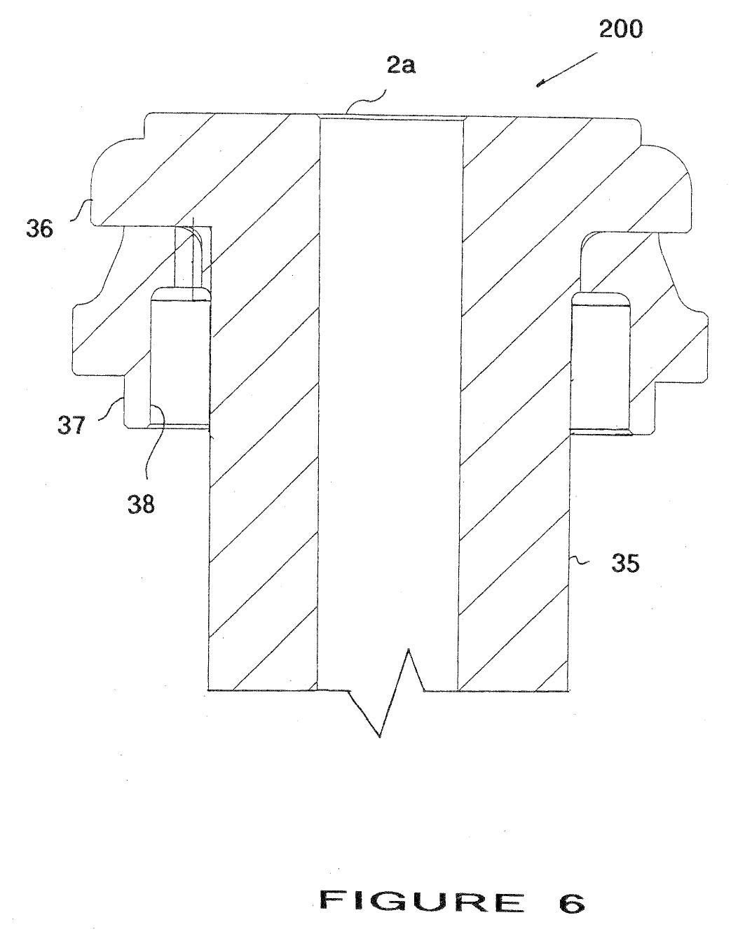

Referring next to FIG. 6, a preferred nozzle body design is generally referenced 200. In this embodiment the nozzle body 200 is provided with a shank portion 35 and a radially extending flange portion 36 at or adjacent the inlet 2a. A substantially annular member 37, which is manufactured as a separate component, is connected to the shank portion 35 underneath the flange portion 36. The annular member 37 is preferably pressed onto the shank portion 35, but may also be connected by any suitable alternative means of connection. In some embodiments resistance welding may be used to connect the annular member 37 to the shank portion 35. The annular member 37 is provided with an internal annular rebate 38 so that it is able to slide over the heater means, as with the nozzle bodies of the prior art.

Those skilled in the art will appreciate that by providing the annular member 37 as a separate component the choice of material for the annular member 37 is increase, as it is not necessary to make the annular member 37 out of the same hardened steel which is usually used for nozzle bodies. In some embodiments the annular member 37 maybe manufactured from a material with a relatively low thermal conductivity, such as titanium, in order to minimise heat loss.

The separate annular member 37 also facilitates creation of the internal annular rebate, both by allowing the component to be manufactured from a more easily machined material than that used for the rest of the body, and by changing the nature of the machining step. In the nozzle bodies of the prior art a long, narrow annular slot is cut into the nozzle body, whereas the annular member 37 of the present invention only requires the creation of an internal annular rebate as shown in FIG. 6.

Where in the foregoing description, reference has been made to specific components or integers of the invention having known equivalents then such equivalents are herein incorporated as if individually set forth.

Although this invention has been described by way of example and with reference to possible embodiments thereof, it is to be understood that modifications or improvements may be made thereto without departing from the scope or spirit of the invention.

1-33. (canceled)

34. An injection moulding tip for an injection moulding nozzle assembly, the tip including;
An inlet at a first end,
An outlet at a second end,
A flow path between the inlet and the outlet,
A first portion adjacent to the first end having a first diameter,
A second portion, adjacent to the second, end having a second diameter,
And a central portion between, the first and second, portions, the central portion having a diameter that is greater than the first diameter and greater than the second, diameter.

35. The injection moulding tip of claim 34 wherein an external surface of the central portion is continuous with an external surface of a nozzle body to which the tip is to be connected.

36. The injection moulding tip of claim 34 wherein the first portion of the tip is adapted to connect to a nozzle body.

37. The injection, moulding tip of claim 34 wherein, the second portion of the tip is adapted to be connected to a locating means for locating the nozzle assembly relative to a mould.

38. The injection moulding tip of claim 34 wherein the flow path is provided by a tip liner which comprises an integral part of the tip.

39. The injection moulding tip of claim 34 wherein the flow path comprises a separable component from the tip.

40. The injection moulding tip of claim 34 wherein the first and second portions each include an external thread.

41. The injection moulding tip of claim 34 wherein the tip is constructed from a highly thermally conductive material.

42. The injection moulding tip of claim 41 wherein the tip is constructed from beryllium, copper.

43. The injection moulding tip of claim 41 wherein the tip is constructed from a highly thermally conductive carbide material.

44. The injection moulding tip of claim 34 wherein the locating means comprises a material having a significantly lower thermal conductivity than the material of the tip.

45. The injection moulding tip of claim 34 wherein the nozzle body comprises a material having a significantly lower thermal conductivity than the tip.

46. An injection moulding tip for an injecting moulding nozzle, the tip being constructed from a highly thermally conductive material, and including;
A first portion for connection to the nozzle body,
A second portion for connection to a locating means,
A central portion disposed between the first and second portions, the central portion having an external surface adapted to contact a heating means.

47. The injection moulding tip of claim 46 wherein the tip comprises at least 20% of the total mass of a nozzle assembly with which it is connected in use.

48. The injection moulding tip of claim 46 wherein the tip includes a sleeve and a tip liner provided inside the sleeve, the tip liner defining a flow path, wherein the sleeve comprises at least 14% of the total mass of a nozzle assembly with which it is connected in use.

49. The injection moulding tip of claim 46, wherein the sleeve is substantially double the mass of the tip liner.

50. The injection moulding tip of claim 46, wherein, the central, portion of the tip comprises at least substantially 50% of the total mass of the tip excluding the tip liner.

51. An injection moulding nozzle including;
A nozzle body;
a tip adapted, for provision on the body, the tip having an inlet, an outlet, a fluid flow path between the inlet and the outlet, a shank portion between the inlet and the outlet, and an external, surface of the shank portion being adapted to contact a heating means.

52. The injection moulding nozzle of claim 51 wherein the tip has a nigh thermal conductivity.

53. The injection moulding nozzle of claim 51 wherein the shank portion includes a sleeve, an outer surface of which provides the external, surface of the shank portion which is adapted to contact the heating means, and a tip liner provided within the sleeve in which the flow path, is provided.

54. The injection moulding nozzle of claim 53 wherein the sleeve is in intimate thermal contact with the tip liner between the inlet and said at least one outlet.

55. The injection moulding nozzle of claim 53 wherein the sleeve has a high thermal conductivity.

56. The injection moulding nozzle of claim 53 wherein the tip liner has a high thermal conductivity.

57. Tins injection moulding nozzle of claim 51 wherein the nozzle includes a heating means in contact with the outer surface of the sleeve.

58. The injection moulding nozzle of claim 51 wherein the nozzle includes a cover or housing and the heating means is attached to or integral with said cover or housing.

59. The injection moulding nozzle of claim 53 wherein the sleeve has a thermal conductivity of at least three times that of the housing and/or nozzle body.

60. The injection moulding nozzle of claim 59 wherein the sleeve has a thermal conductivity of at least five times that of the housing and/or nozzle body.

61. The injection moulding nozzle of claim 51 wherein the nozzle includes a body having an inlet, an outlet and a fluid path extending between the inlet and the outlet, wherein in use the body positioned such that the outlet is in fluid communication with the inlet of the tip.

62. The injection moulding nozzle of claim 51 wherein the tip is constructed from beryllium copper.

63. The injection moulding nozzle of claim 53 wherein the tip liner is constructed from a carbide having a thermal conductivity approximately equal to that of the sleeve.

64. The injection moulding nozzle of claim 53 wherein the sleeve extends substantially the distance between the inlet and outlet of the elongate tip.

65. The injection moulding nozzle of claim 51 wherein the tip has a first end adapted for disposal internally of the body and a second end adapted for disposal internally of the locating means.

66. The injection moulding nozzle of claim 53 the sleeve has a first end adapted for disposal internally of the body and a second end adapted for disposal internally of the locating means.
